(19) United States
(12) Patent Application Publication
(10) Pub. No.: US 2016/0110599 A1
(43) Pub. Date: Apr. 21, 2016

(54) Document Classification with Prominent Objects

(71) Applicant: Lexmark International Technology, SA, Meyrin (CH)

(72) Inventors: Suman Das, Kolkata (IN); Ranajyoti Chakraborti, Kolkata (IN)

(21) Appl. No.: 14/517,987

(22) Filed: Oct. 20, 2014

(51) Int. Cl. G06K 9/00

(52) U.S. Cl. CPC G06K 9/00483; G06K 9/00456; G06K 9/00463

(57) ABSTRACT

Systems and methods classify unknown documents in a group or not with reference document(s). Documents get scanned into digital images. Applying edge detection allows the detection of contours defining pluralities of image objects. The contours are approximated to a nearest polygon. Prominent objects get extracted from the polygons and derive a collection of features that together identify the reference document(s). Comparing the collection of features to those of an unknown image determine or not inclusion of the unknown with the reference(s). Embodiments typify collections of features, classification acceptance or not, application of algorithms, and imaging devices with scanners, to name a few.

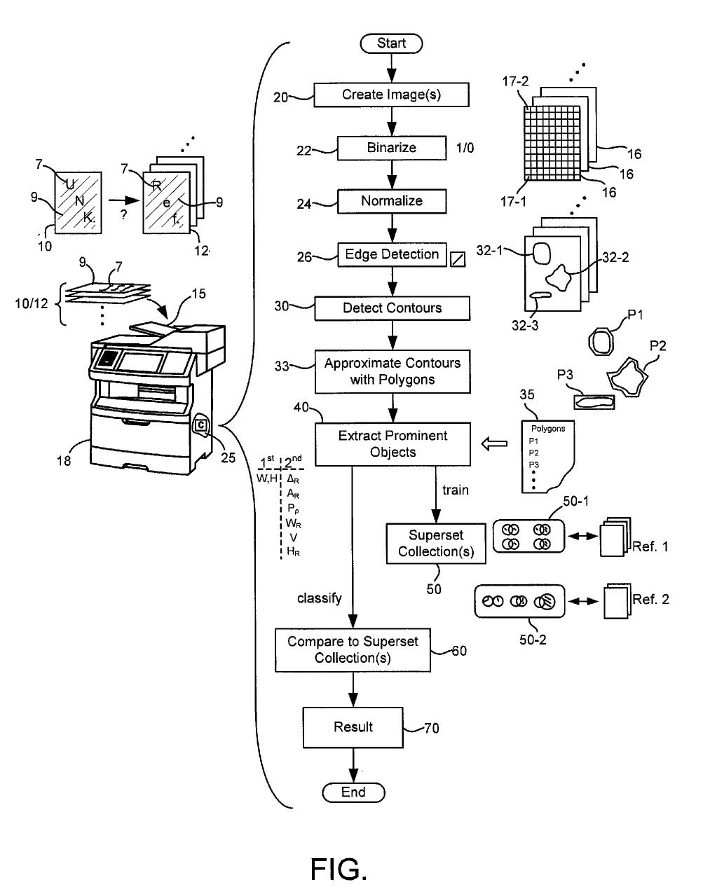

### FIELD OF THE EMBODIMENTS

The present disclosure relates to classifying or not unknown documents with a group of reference document(s). It relates further to classifying with prominent objects extracted from images corresponding to the documents. Classification without regard to optical character recognition (OCR) is a representative embodiment as is execution on an imaging device having a scanner and controller.

### BACKGROUND

In traditional classification environments, a document becomes classified or not by comparison to one or more known or trained reference documents. Categories define the references in a variety of schemes and documents get compared according content, attributes, or the like, e.g., author, subject matter, genre, document type, size, layout, etc. In automatic classification, a hard copy document becomes digitized for computing actions, such as electronic editing, searching, storing, displaying, etc. Digitization also launches routines, such as machine translation, data extraction, text mining, invoice processing, archiving, displaying, sorting, and the like. Optical character recognition (OCR) is a conventional technology used extensively during the routines.

Unfortunately, OCR requires intensive CPU processes and extended periods of time for execution which limits its effectiveness, especially in systems having limited resources. OCR also regularly fails its role of classifying when documents have unstructured formats or little to no ascertainable text. Poorly scanned documents having skew or distortion (e.g., smudges, wrinkles, etc.) further limit the effectiveness of OCR.

A need in the art exists for better classification schemes for documents. The need extends to classification without OCR and the inventors recognize that improvements should contemplate instructions or software executable on controller(s) for hardware, such as imaging devices able to digitize hard copy documents. Additional benefits and alternatives are also sought when devising solutions.

### SUMMARY

The above-mentioned and other problems are solved by document classification with prominent objects. Systems and methods serve as an alternative to OCR classification schemes. Similar to how humans remember and identify documents without knowing the language of the document, the following classifies documents based on prominent features or objects found in documents, such as logos, geometric shapes, unique outlines, etc. The embodiments occur in two general stages: training and classification. During training, prominent features for known documents are observed and gathered in a superset collection of features that together define the documents. Features are continually added until there is no enlargement of the set or little measurable growth. During classification, unknowns (document singles or batches) are compared to the supersets. The winning classification notes the highest amount of correlation between the unknowns and the superset.

In a representative embodiment, systems and methods classify unknown documents in a group or not with reference document(s). Documents get scanned into digital images. Applying edge detection allows the detection of contours defining pluralities of image objects. The contours are approximated to a nearest polygon. Prominent objects are extracted from the polygons and derive a collection of features that together identify the reference document(s). Comparing the collection of features to those of an unknown image determine or not inclusion of the unknown with the reference(s). Embodiments typify collections of features, classification acceptance or not, application of algorithms, and imaging devices with scanners, to name a few.

These and other embodiments are set forth in the description below. Their advantages and features will become readily apparent to skilled artisans. The claims set forth particular limitations.

### BRIEF DESCRIPTION OF THE DRAWING

The sole FIGURE is a diagrammatic view of a computing system environment for document classification, including flow chart according to the present disclosure.

### DETAILED DESCRIPTION OF THE ILLUSTRATED EMBODIMENTS

In the following detailed description, reference is made to the accompanying drawing where like numerals represent like details. The embodiments are described to enable those skilled in the art to practice the invention. It is to be understood that other embodiments may be utilized and that changes may be made without departing from the scope of the invention. The following, therefore, is not to be taken in a limiting sense and the scope of the embodiments is defined only by the appended claims and their equivalents. In accordance with the features of the invention, methods and apparatus teach document classification according to prominent objects.

With reference to the FIGURE, an unknown input document 10 is classified or not as belonging to a group of one or more reference documents 12. The documents are any of a variety, but commonly hard copies in the form of invoices, bank statements, tax forms, receipts, business cards, written papers, books, etc. They contain either text 7 and/or background 9. The text typifies words, numbers, symbols, phrases, etc. having content relating to the topic of the document. The background represents the underlying media on which the content appears. The background can also include various colors, advertisements, corporate logos, watermarks, textures, creases, speckles, stray marks, row/column lines, and the like. Either or both the text and background can be formatted in a structured way on the document, such as that regularly occurring with a vendor's invoice, tax form, bank statement, etc., or in an unstructured way, such as might appear with a random, unique or unknown document.

Regardless of type, the documents 10, 12 have digital images 16 created at 20. The creation occurs in a variety of ways, such as from a scanning operation using a scanner and document input 15 on an imaging device 18 and as manipulated by a controller 25. The controller can reside in the imaging device 18 or elsewhere. The controller can be a microprocessor(s), ASIC(s), circuit(s) etc. Alternatively, the image 20 comes already created from a computing device (not shown), such as a laptop, desktop, tablet, smart phone, etc. In either, the image 16 typifies a grayscale, color or other multi-valued image having pluralities of pixels 17-1, 17-2, . . . . The pixels define text and background of the documents 10, 12 according to their pixel value intensities. The amounts of pixels in the images are many and depend in volume upon the resolution of the scan, e.g., 150 dpi, 300 dpi, 1200 dpi, etc. Each pixel also has an intensity value defined according to various scales, but a range of 256 possible values is common, e.g., 0-255. The pixels may also be in binary form 22 (black or white, 1 or 0) after conversion from other values or as a result of image creation at 20. In many schemes, binary creation occurs by splitting in half the intensity scale of the pixels (0-255) and labeling as black pixels those with relatively dark intensities and white pixels those with light intensities, e.g., pixels 17 having intensities ranging from 0-127 become labeled black, while those with intensities from 128-255 become labeled white. Other schemes are also possible.

Regardless, the pluralities of images are normalized at 24 to remove the variances from one image to a next. Normalization rotates the images to a same orientation, de-skews them and resizes each to a predefined width and height. The width (W) and height (H) are calculated as:

W=μ_{W}×μ [symbol] _{_{w}}, where μ_{W}=the mean of the distribution of standard media size widths, e.g., 8.5 inches in a media of 8.5 inches×11 inches, and μ_{R}_{_{w}}=the mean of the distribution of standard horizontal resolutions; and

[symbol] =μ_{H}×μ_{R}_{_{H}}, where μ_{H}=the mean of the distribution of standard media size heights, e.g., 11 inches in a media of 8.5 inches×11 inches, and μ_{R}_{_{H}}=the mean of the distribution standard vertical resolutions. In most printed documents, μ_{R}_{_{w}}=μ_{R}_{_{H}}, because the horizontal and vertical resolutions are the same, e.g., 300×300 dpi.

Once normalized, edge detection 26 is performed on each of the images. There are popular forms of edge detection, such as a Canny edge detector. The edges are used to detect or extract 30 the external contours 32-1, 32-2, 32-3 of various objects. At 33, the extracted contours are approximated to nearest polygon (P). For example, each of objects 32 can be approximated to a polygon of similar size and shape. Object 32-3 having a generally lengthwise extent and little height can be surrounded decently by a rectangular polygon P3. Similarly, object 32-1 having a near circular shape can be approximated by an octagon polygon P1. The polygons in practice can be regular or irregular. They can have any number of sides and define convex, concave, equilateral, or equiangular, etc. features. Once the polygons define the objects, the polygons are next established on a list 35.

The controller 25 then executes fuzzy logic on each of the polygons to extract the more prominent of the objects of the image as defined by the polygons (P) approximated to represent those same objects. In one embodiment, the fuzzy logic relies on secondary attributes (2^{nd}) of the objects in order to select those object samples which look prominent to the human eye. The secondary attributes are derived from primary attributes (1^{st}) of the objects, of which the primary attributes are width and height of the polygon. Some of the secondary attributes include relative area, aspect ratios, pixel density, relative width and relative height, and vertices of the polygons. In one embodiment, the secondary attributes are defined as follows (where subscript (o) references the object itself 32 or the polygon P defining the object and the subscript (l) references the whole image created at 20 and preferably normalized at 24):

Relative Area Δᵣ=Δₒ÷Δ_{I} where Δₒ is the area of the object and Δ_{I} is the area of the image;

$$Aspect Ratio of Object {AR}_{o} = {𝒲}_{o} \div {ℋ}_{o} ;$$

$$Pixel Density {P}_{d} = \frac{\# Black Pixels}{\# White Pixels} ;$$

$$Relative Width {W}_{R} = \frac{{W}_{O}}{{W}_{I}} ;$$

$$Relative Height {H}_{R} = \frac{{H}_{O}}{{H}_{I}} ;$$

and

Vertices: a number of vertices of the approximated polygon P.

During the document training phase (train), the attributes help reveal or define documents relative to other documents. In turn, those attributes or features which define a particular document (e.g., reference #1 or reference #2) are collected together as a superset collection of features 50. For instance, a reference document in the form of a U.S. Tax Form 1099-int might be known by 50-1 having a particular aspect ratio of objects in the tax form, pixel density, etc. while a distinguishable, second reference document in the form of a U.S. Tax Form 1099-Misc known by 50-2 having a particular relative area and vertices. In turn, collections of features 50-1 define reference #1 and such is distinguishable mathematically from collections of features 50-2 defining reference #2.

Also, training of the documents occurs typically in series. A first document of a known type (U.S. Tax Form 1099-Int) is detected for its prominent objects and its features are supplied to an empty set of features. Then a next document of the same type is added to the collection 50 and so on. If a feature corresponding to the document being trained does not already exist in the collection of features, a new category of features is created and added to the collection and continues until all such features are gathered that define the document.

In a simplified example, a first document undergoing training may reveal a prominent object at 40 having an Aspect Ratio feature of 2.65. A next document of the same type undergoing training might have a same prominent object having an Aspect Ratio feature of 2.71. In turn, the Aspect Ratio feature for this object ranges from 2.65-2.71. Now if a third document of the same type has the same prominent object with an Aspect Ratio feature of 2.74, the Aspect Ratio feature gets added to the superset already created and such now ranges from 2.65-2.74. On the other hand, if a fourth document of the same type gets trained and has an Aspect Ratio feature of 2.69, such is already found in the set and so there is no adding of it to the range. And the process continues/iterates in this manner.

Naturally, certain features are more complicated than the simple example noted for Aspect Ratios. For example, it should be determined whether a feature is statistically close enough to the earlier features to determine whether it belongs or not in the superset collection of features. Mathematically, let A and B be the Superset and Selected Objects Set from the Normalized document. Let i be the current iteration of training, then the Superset at iteration i+1 is

Aᵢ₊ᵢ=[(A]ᵢ∪B)−(Aᵢ∩B) where 0≦i≦n.

The objects which already exist in the Superset (Aᵢ∩B) will not be added to the superset. Each selected object, however, is matched with objects in the superset by calculating the likelihood of the selected object being in the superset. To calculate the likelihood, a Mahalanobis Distance (Dₘ) is first calculated and then the likelihood (L_{Dm}) is calculated from that as below:

Dₘ=\sqrt{(x−μ)^{T}S⁻¹(x−μ)},

where x=(x₁, x₂, x₃, . . . x_{N}) are the attributes of a selected object and μ is the mean of each column's vector. S is the covariance matrix. Likelihood:

L_{D}_{ₘ}=e^{-(D}^{ₘ}⁾^{²}

Once the superset collection of features has been established for the one or more reference documents having undergone training, an unknown is compared to the superset(s) to see if it belongs or not to a group with the reference documents (classify). At 60, the features of the prominent objects of the unknown extracted at 40 are compared to the collections of features 50 defining the reference or known documents. The closest comparison between them defines the result of the classification at 70.

In more detail, the features of the prominent objects of the unknown extracted at 40 are compared with the superset collection of features 50 and that with the closest Bhattacharyya Distance (D_{b}) defines the unknown. The Bhattacharyya distance is given as:

$${D}_{b} = \frac{1}{8} {( {μ}_{1} - {μ}_{2} )}^{T} {S}^{- 1} ( {μ}_{1} - {μ}_{2} ) + \frac{1}{2} {log}_{e} ( \frac{\vert S \vert}{\sqrt{\vert {S}_{1} \vert \vert {S}_{2} \vert}} ) ,$$

where
μᵢ and Sᵢ are mean and Covariance matrix

$$S = \frac{{S}_{1} + {S}_{2}}{2} .$$

The Bhattacharyya distance gives a unit-less measure of the divergence of the two sets. Based on D_{b}, ranking of the labels corresponding to the compared Supersets is done. The label with the highest rank is the winner and is the result of the classification. Relative advantages of the foregoing include incorporation with a lightweight engine compared to OCR-based systems, thus can be executed as an embedded solution in a controller and can replace OCR-based systems.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments.

1. In a computing system environment, a method for classifying whether or not an unknown input document belongs to a group with one or more reference documents, wherein digital images correspond to each of the unknown input document and the one or more reference documents, comprising:
applying edge detection to the digital images to detect contours of pluralities of image objects;
approximating the contours of the image objects to a nearest polygon thereby defining pluralities of polygons;
extracting prominent objects from one or more of the polygons to derive a collection of features that together identify the one or more reference documents; and
comparing to the collection of features at least one prominent object from the digital image corresponding to the unknown input document to determine inclusion or not of the unknown input document with the one or more reference documents.

2. The method of claim 1, further including determining a relative area between an object of one of the digital images to a whole area of said one of the digital images for inclusion in the collection of features.

3. The method of claim 1, further including determining an aspect ratio of an object in one of the digital images for inclusion in the collection of features.

4. The method of claim 1, further including determining a pixel density of an object of one of the digital images for inclusion in the collection of features.

5. The method of claim 1, further including determining a relative width or relative height between an object of one of the digital images to a whole width or height respectively of said one of the digital images for inclusion in the collection of features.

6. The method of claim 1, further including determining vertices of the nearest polygon of an object of one of the digital images for inclusion in the collection of features.

7. The method of claim 1, further including normalizing the digital images created that correspond to the unknown input document and the one or more reference documents.

8. The method of claim 7, wherein the normalizing includes rotating, de-skewing and sizing each of the digital images to a predefined width, height, and orientation and setting a common resolution.

9. The method of claim 1, further including binarizing each of the digital images.

10. The method of claim 1, wherein the comparing further includes applying Bhattacharyya distance.

11. The method of 1, further including ranking a comparison of the at least one prominent object to more than one said collection of features.

12. The method of claim 11, wherein the highest ranking of the comparison determines said inclusion or not of the unknown input document with the one or more reference documents.

13. The method of claim 1, further including scanning the unknown input document and the one or more reference documents to obtain the images corresponding thereto.

14. The method of claim 13, wherein the scanning to obtain the images does not further include processing the images with optical character recognition.

15. The method of claim 1, further including classifying additional unknown documents relative to the one or more reference documents.

16. In an imaging device having a scanner and a controller for executing instructions responsive thereto, a method for classifying whether or not an unknown input document belongs to a group with one or more reference documents, comprising:
receiving at the controller a digital image from the scanner for each of the unknown input document and the one or more reference documents;
applying edge detection to the digital images to detect contours of pluralities of image objects;
approximating the contours of the image objects to a nearest polygon thereby defining pluralities of polygons; and
extracting prominent objects from one or more of the polygons to derive a collection of features that together identify the one or more reference documents.

17. The method of claim 16, further including comparing to the collection of features at least one prominent object from the digital image corresponding to the unknown input document to determine inclusion or not of the unknown input document with the one or more reference documents.

18. A method for classifying whether or not an unknown input document belongs to a group with one or more reference documents, wherein digital images correspond to each of the unknown input document and the one or more reference documents, comprising:
applying edge detection to the digital images to detect contours of pluralities of image objects; and
determining features of prominent objects from the pluralities of image objects to derive a collection of features that together identify the one or more reference documents.

19. The method of claim 18, further including comparing to the collection of features at least one feature of a prominent object from the digital image corresponding to the unknown input document to determine inclusion or not of the unknown input document with the one or more reference documents.

20. The method of claim 18, further including approximating the contours of the image objects to a nearest polygon.
